(19) United States
(12) Patent Application Publication
(10) Pub. No.: US 2016/0033209 A1
(43) Pub. Date: Feb. 4, 2016

(54) REDUCED THERMAL EXPANSION MICROCHANNEL COOLERS

(71) Applicant: Geoffrey O. Campbell, Broomfield, CO (US)

(72) Inventor: Geoffrey O. Campbell, Broomfield, CO (US)

(21) Appl. No.: 14/736,367

(22) Filed: Jun. 11, 2015

Related U.S. Application Data
(60) Provisional application No. 62/030,756, filed on Jul. 30, 2014.

(51) Int. Cl. F28F 3/04; F28F 3/08; F28F 21/00; B23P 15/26

(52) U.S. Cl. CPC F28F 3/04; B23P 15/26; F28F 3/08; F28F 21/00

(57) ABSTRACT

Disclosed are microchannel coolers having a cooling surface with a Coefficient of Thermal Expansion (CTE) designed to match (or reduce the mismatch) a CTE of a heat generating device. Such coolers are formed of foils or plates that are laminated together to form a cooling structure. The foils are formed of differing materials and these foils alternate in the laminated structure to tailor the CTE of the cooling surface of the cooler to between the CTEs of the different foils forming the cooler.

### CROSS REFERENCE

The present application claims the benefit of the filing date of U.S. Provisional Application No. 62/030,756 having a filing date of Jul. 30, 2014, the entire contents of which is incorporated herein by reference.

### FIELD

The present disclosure relates to microchannel coolers formed of thin laminated plates or foils. More specifically, the present disclosure relates to microchannel coolers formed of thin plates or foils of at least first and second different materials having differing Coefficients of Thermal Expansion (CTE), which allow tailoring an overall CTE of a cooling surface of the cooler to better match a CTE of an electronic component thermally attached to the cooling surface.

### BACKGROUND

Advances in semiconductor processing and circuit design have led to increased component density in numerous semiconductor circuits/devices (e.g., laser diodes). While the individual components making up such semiconductor devices operate at low voltage and draw very low currents, the increased density of components in such devices has a consequential increase in heat generated per unit area of device surface. This has necessitated the use of heat sinks to facilitate removal of heat from the surface.

One type of heat sink that has been utilized for cooling semiconductor devices is a commonly referred to as a microchannel cooler. The microchannel cooler is a cooling device that utilizes a fluid to remove heat from at least one surface (e.g., cooling surface) that may be attached to a semiconductor device. One form of the modern metal microchannel cooler includes a plurality of thin plates or foils which have been laminated together to form a block. Often, the plates are thin copper foil strips each having a microscopic recessed portion etched into one face of the plate. These recessed portions are chemically etched to a shallow dimension on the order of, for example, 10-50 microns deep prior to lamination. These recessed portions define flow paths when the thin plates are laminated together.

Either before or after the plates are laminated together to form the block, passages are cut through the plates at opposite sides of the recessed portions such that, when the stack is laminated, the passages align to form a pair of coolant distribution manifolds. Each of the manifolds is essentially a conduit which penetrates into the resulting heat exchanger block. The passages or conduits are connected via the plurality of microscopic channels (i.e., flow paths) formed from the recessed portions during the lamination process. Typically, the microchannel cooler is bonded onto the surface of a semiconductor device to effectuate heat removal.

### SUMMARY

The present disclosure is directed to microchannel coolers having a cooling surface with a Coefficient of Thermal Expansion (CTE) designed to match (or reduce the mismatch) a CTE of a heat generating device. Such coolers are formed of foils or plates that are laminated together to form a cooling structure. The foils are formed of differing materials and these foils alternate in the laminated structure to tailor the CTE of the cooling surface of the cooler.

According to a first aspect, a microchannel cooler is provided that is formed of the first set of first foils/plates made of a first material and a second set of second foils/plates made of a second material. The first and second sets of foils each typically include first and second planar surfaces and a peripheral edge. The first and second sets of foils alternate in a laminated/bonded stack. The foils are bonded face-to-face. Typically, the foils each include a flat edge that is aligned during bonding to provide a planar composite surface (e.g., cooling surface) formed of alternating edges of the first and second foils. However, such a planar surface may be milled after the foils are bonded/laminated.

The first and second materials have different thermal properties. Typically, the first material has a first coefficient of thermal expansion or CTE and a first thermal conductivity. In contrast, the second material has a second lower coefficient of thermal expansion or CTE and, typically, a second lower thermal conductivity. The resulting CTE of the cooling surface of the composite structure, in a direction normal to the planar surfaces of the alternating foils in the stack, is a thickness-weighted average of the first CTE and second CTE. In directions in the plane of the foil surfaces, the resultant CTE of the composite structure is a function of the first and second CTE and the strengths of the first and second materials. In this regard, the CTE of the cooling surface of the cooler may be tailored between the first and second CTEs. Further, the thermal resistance of the cooler will be between a first thermal resistance of a physically identical cooler made entirely of the first material and a second thermal resistance of a physically identical cooler made entirely of the second material. However, in preferred designs, the thermal resistance of the cooler will be closer to a thermal resistance of a physically identical cooler made entirely of the first material (i.e., the higher thermal conductivity material).

To provide an active cooling surface for the cooler, the first and second foils collectively define flow channels within the structure of the cooler. These flow channels extend between fluid distribution passages, which typically extend through the structure in a direction normal to the faces of the foils, though more complex geometries and/or branching networks of fluid distribution passages may be employed. In operation, the fluid distribution passages are attached to manifolds, which circulate fluid through the fluid distribution passages and the flow channels. To provide improved thermal resistance for the surface of the cooler, the flow channels are typically formed entirely within the foils of the lower thermal conductive material.

In one arrangement, the flow channels are formed as a recess or aperture that extend into or through the lower thermal conductivity foils. When laminated or bonded to adjacent higher thermal conductivity foils these flow channels are at least partially covered by a solid portion of the adjacent higher conductivity material. In this regard, the higher conductivity foils form heat fins that extend into the flow passageways. This allows the thermal resistance the cooler to approach a thermal resistance of a cooler made entirely of the higher thermal conductivity material. In various arrangements, the thermal resistance of the cooler may be within 20%, 10% or even 5% of an identical cooler made entirely of the higher thermal conductivity material.

The materials utilized to form the first and second foils may be materials that allow for generating desired thermal characteristics. Typically, the first foil material will have a CTE of at least 10 ppm/K and more typically at least 14 ppm/K. In contrast, the second foil material will typically have CTE of less than 10 ppm/k. Further, the first foil material will typically have a thermal conductivity of at least 180 W/mK and more typically of at least 200 W/mK. In contrast, the second foil material will typically a thermal conductivity of at less than 180 W/mK and more typically of at less than 150 W/mK.

### BRIEF DESCRIPTION OF THE FIGURES

FIG. 1 illustrates one embodiment of microchannel cooler formed of repeating foil layers;

FIG. 2 shows and exploded view of the microchannel cooler of FIG. 1.

FIG. 3 shows a graph of thermal conductivity vs. Coefficient of Thermal Expansion (CTE) for various materials.

FIG. 4 illustrates one embodiment of a microchannel cooler formed of foil layers of alternating materials.

FIG. 5 illustrates a partial cross-sectional view of the microchannel cooler of FIG. 4.

### DETAILED DESCRIPTION

Reference will now be made to the accompanying drawings, which at least assist in illustrating the various pertinent features of the various presented inventions. The following description is presented for purposes of illustration and description and is not intended to limit the various inventions to the forms disclosed herein. Consequently, variations and modifications commensurate with the following teachings, and skill and knowledge of the relevant art, are within the scope of the presented inventions. The embodiments described herein are further intended to explain the best modes known of practicing the various inventions and to enable others skilled in the art to utilize the inventions in such, or other embodiments and with various modifications required by the particular application(s) or use(s) of the presented inventions.

Disclosed herein are microchannel coolers or heat dissipating/spreading devices (hereafter ‘coolers’) that reduce the thermal expansion mismatch between the coolers and heat generating devices (e.g., semiconductor device) in thermal contact with a cooling surface(s) of the coolers while maintaining low thermal resistance. Generally, the coolers are formed of two or more materials having differing Coefficients of Thermal Expansion (CTE) and thermal conductivities. In most embodiments, the two materials form a composite cooling surface of alternating materials for thermal contact with a heat generating device. This composite cooling surface may be tailored to have CTE that is closer to the CTE of the heat generating device while maintaining low thermal resistance. Generally, for purposes of this discussion, a “microchannel cooler” is a cooler or cold plate having coolant flow channels with a hydraulic diameter of less than 1.0 mm and more typically less than 0.5 mm or even 0.25 mm. That is:

H_{d}=2*w*h/(w+h) eq. (1)

where w is the flow channel width; and

h is the flow channel height.

Of course, the hydraulic diameter may vary based on the exact configuration of the flow channel. That is, other equations may be utilized to define the hydraulic diameter. Regardless of the exact flow channel configuration or its calculated, the hydraulic diameter is typically less than 1.0 mm.

The inventor has recognized that heat generating devices such as semiconductor devices suffer from stresses induced during the cool-down process after brazing or soldering to the generally metallic coolers and/or passive thermal spreaders. Since the coolers are generally made of materials having high thermal conductivities such as copper or aluminum, they often have a Coefficient of Thermal Expansion (CTE) 2½ times larger than the expansion of, for example, a silicon or gallium arsenide wafer, the base materials of most electronic and laser diode devices, respectively. For instance, at standard conditions, the CTE of gallium arsenide is approximately 6.9*10⁻⁶/K (i.e., 6.9 ppm/K) whereas the CTE of copper is approximately 17.7*10⁻⁶/K and the CTE of aluminum is approximately 23.1*10⁻⁶/K. When the wafers are soldered/brazed to the coolers/spreaders, the joint hardens at relatively high temperatures. Upon cool-down, the differing thermal expansion rates of the two materials lead to large stresses in the joint and in the materials themselves. In addition, temperature cycling due to the external environment (e.g., hot/cold weather storage) or due to operational cycling (variable power loads and on/off cycling) can lead to creep or fatigue at bond joints. This can lead to premature failure of the bond joint, which generally leads to catastrophic failure of the semiconductor devices/electronics.

To mitigate this effect, semiconductor packaging engineers use either: 1) a soft bond, such as ductile solder; or 2) a hard bond with an expansion-matched substrate (typically a ceramic with high thermal conductivity) between the semiconductor device and the typically metallic heat sink or cooler. Both approaches increase thermal resistance between the device and the heat sink, and soft bonds can be subject to creep and other aging effects.

The increase in thermal resistance is particularly important at high power levels, where high performance microchannel coolers are required to dissipate waste heat fluxes while maintaining junction temperatures at acceptable levels. Liquid-cooled microchannel coolers/cold plates have extremely low thermal resistances (roughly two orders of magnitude below conventional cold plates) and have become the preferred means of accommodating heat fluxes in excess of 500 W/cm². Adding an expansion-matched substrate between the semiconductor device and such a high performance cooler can more than double the total thermal resistance between the junction and the coolant.

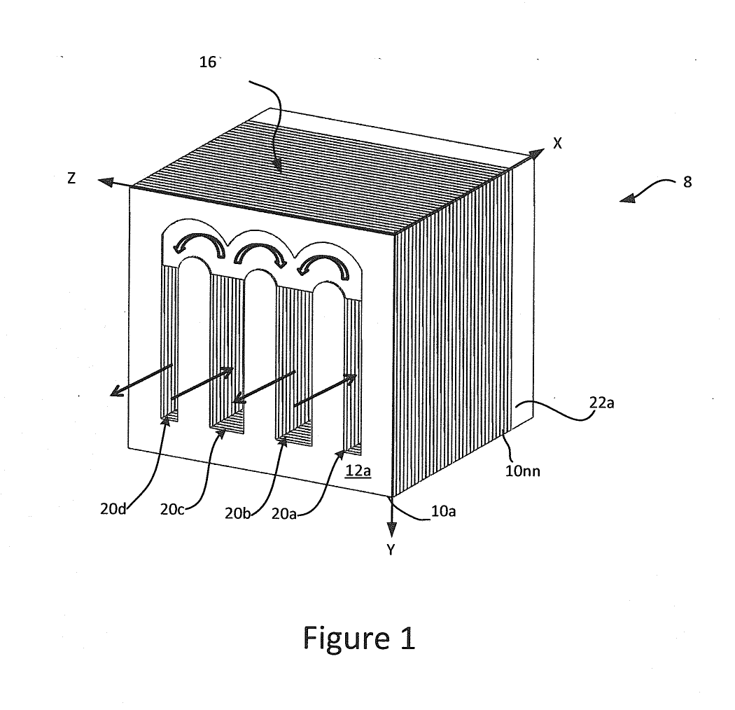

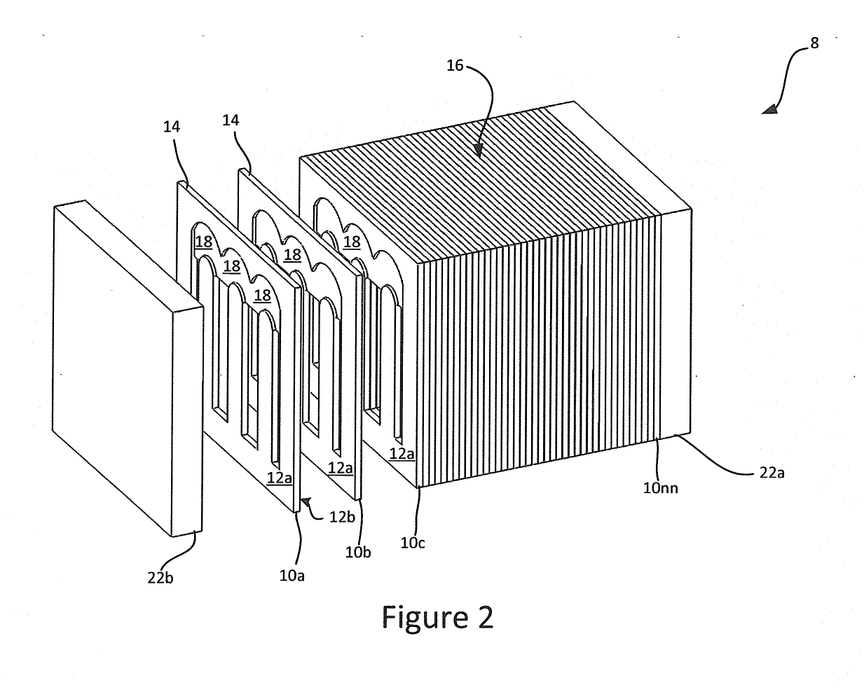

The design characteristics of one exemplary microchannel cooler 8 are shown in FIGS. 1 and 2. The cooler 8 is formed from a set of stacked plates or foils 10a-10nn (hereafter 10 unless specifically referenced). When the foils 10 are each formed of the same material, the microchannel cooler is a conventional cooler. In the illustrated embodiment, each of the foils 10 is a substantially rectangular member having first and second planar surfaces or faces 12a and 12b. The thickness of the foil 10 between the faces 12a and 12b defines a peripheral edge of the foil 10. In the illustrated embodiment, at least the top edge 14 of each foil 10 is a flat edge. Accordingly, when the foils 10 are stacked, the top edge 14 of a foil is aligned with the top edge(s) of adjacent foils. Typically, the mounting surface 16 is machined and polished after the foils are stacked and bonded/laminated. Collectively, the top edges 14 of the foils 10 define a planar cooling/mounting surface 16 of the cooler 8, which in the illustrated embodiment defines an arbitrary XZ plane. Heat generating devices may be attached to the cooling surface 16 or the cooling surface 16 may affix the cooler 8 to a heat generating device.

In the illustrated embodiment, each of the foils 10 has one or more flow channels 18 recessed into its first face 12a. Typically, each flow channel 18 is a recessed portion that is chemically etched to a shallow dimension on the order of, for example, 10-50 microns deep prior to lamination or bonding of the foils 10. In an exemplary cooler, the foils 10 are 0.05 mm thick, and are half-etched to form 0.025 mm channels 18 (e.g., microchannels). Though discussed as utilizing chemical etching, other methods of forming the recessed flow channels 18 are possible as well.

As best illustrated in FIG. 2, when the foils 10 are stacked, the flow channels 18 recessed into the first face 12a of, for example, foil 10b are at least partially covered by the planar second surface or face 12b of an adjacent foil, for example, foil 10a. In this regard, the flow channels 18 are sealed by an adjacent foil. The flow channels 18, which in the present embodiment are half-etched into each foil 10, extend between fluid distribution passages 20a-20d (hereafter 20 unless specifically referenced) that extend through the thickness of the cooler 8. The number, dimensions, and shape of the flow channels 18 may be varied per the requirements of a given thermal management design. As best shown in FIG. 1, the fluid distribution passages 20a extend through the cooler 8 in a direction that is substantially normal or orthogonal to the faces of the stacked foils 10. For purposes of this disclosure, the direction normal or orthogonal to the faces of the stacked foils is referred to as ‘through the thickness’ or ‘TTT’ of the cooler and is arbitrarily labeled as the X axis/direction. In-plane directions of the foils are arbitrarily labeled Y and Z axes/directions. In the illustrated embodiment, the fluid distribution passages 20 are formed from apertures that extend entirely through each individual foil 10 prior to lamination/bonding of the foils 10. However, it will be appreciated that such fluid distribution passages 20 may be formed into the cooler 8 after the foils are laminated/bonded. That is, fluid distribution passages may be milled or otherwise formed into the cooler 8.

Once the foils 10 are formed, these foils are disposed in a stack such that the flow channels 18 and flow distribution passages 20 are aligned. At this time, the mating faces of the adjacent foils are laminated or bonded together. In one arrangement, such lamination may be performed in a diffusion bonding process. Other processes, such as brazing and soldering, are possible as well. In order to provide fluid flow through the fluid passages 20, each end of the cooler 8 also typically includes an inlet or outlet manifold 22a, 22b (hereafter 22 unless specifically referenced). These manifolds 22 supply and remove coolant to/from the fluid passages 20. The manifolds 22 are illustrative of a general class of manifolds which may be place be placed on any of the cooler sides with the exception of the cooled surface 16. Accordingly, these manifolds are attached to fluid supplies and pumps (not shown). As illustrated in FIG. 1, the manifolds provide bidirectional flow adjacent fluid passages 20. Referring to the fluid passage 20a of FIG. 1, coolant may be provided in a first direction into passage 20a under pressure. The coolant then travels up into the channels 18 defined by adjacent foils 10 and turns 180° to exit via the adjacent fluid passage 20b. Such construction of the cooler 8 allows for removing significant amounts of thermal energy conducted through the planar cooling surface 16.

The approach for producing a microchannel cooler 8 as illustrated in FIGS. 1 and 2 is currently used to fabricate microchannel coolers on a commercial basis foils made of a single material (e.g., copper or copper alloys). Typically, materials such as copper or copper alloys (e.g., Glidcop®) are utilized due to their high thermal conductivity. For instance, copper has a thermal conductivity approaching 400 W/mK. Such high thermal conductivity reduces the thermal resistance of cooler 8. That is, use of high thermal conductivity materials allow heat fluxes to more readily pass into the cooling surface 16 and into the walls adjacent to the flow channels 18 for removal by coolant passing through the cooler. Unfortunately, construction of such high thermally conductive/low thermal resistance cooler with single material foils (e.g., copper foils) results in a cooling surface that has a though the thickness CTE (i.e., X direction as arbitrarily labeled on FIG. 1) that is the same as the material forming the foils. For copper the CTE is approximately 17.7*10⁻⁶/K. Accordingly, for most applications, this results in a large thermal mismatch when the cooling surface is physically connected with a heat generating device/substrate. This typically requires the use of a soft solder and/or an expansion-matched substrate between the semiconductor device and the cooler, which increases the thermal resistance into the cooling surface.

Fabricating microchannel coolers with reduced thermal expansion (i.e., having a reduced CTE mismatch with attached device), in accordance with the present disclosure, allows use of hard solders without the intercession of an expansion-matched substrate, significantly reducing the thermal resistance of the junction between the heat generating device and the cooler. Unfortunately, simply replacing high CTE and high thermal conductivity materials such as copper, copper alloys, aluminum or aluminum alloys, which were previously used in microchannel coolers, with a low-CTE material results in significant degradation of the thermal performance. This is because candidate materials with low thermal expansions <10 ppm/K (e.g., which more closely match the thermal expansion of many semiconductor wafers) such as Invar, Kovar, refractory metals, and refractory metal composites, have thermal conductivities that are significantly lower than copper, copper alloys, aluminum and aluminum alloys. That is, low thermal expansion materials do not have thermal conductivities required for high performance applications (e.g., heat fluxes in excess of 500 W/cm²). Stated otherwise, use of candidate materials with low thermal expansions typically results in significantly increasing the thermal resistance of the cooler.

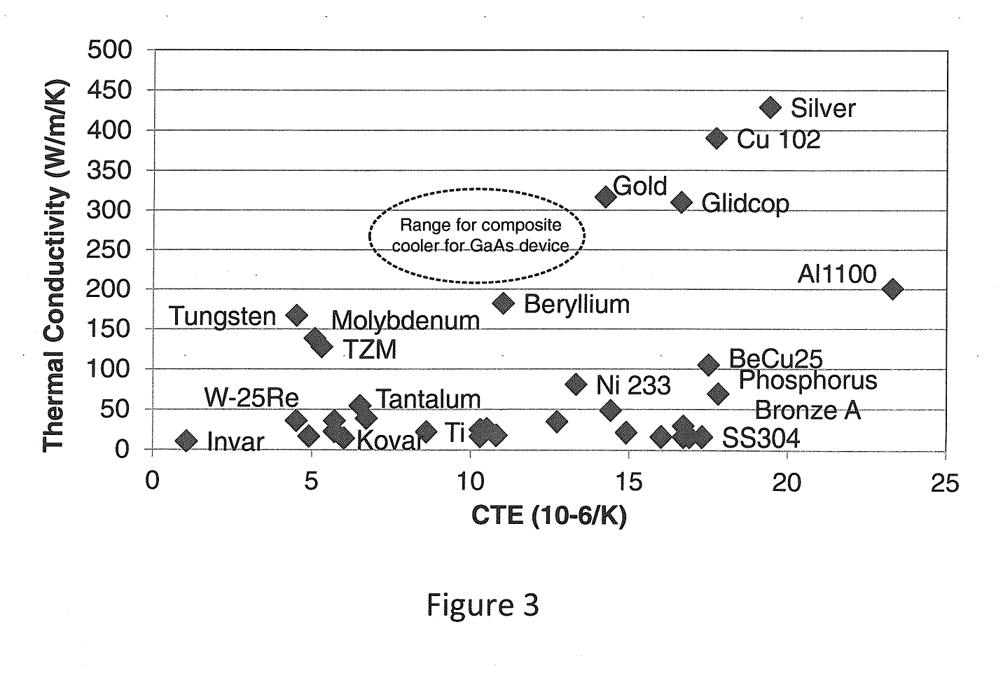

It has been recognized by the inventor that the thermal performance and expansion of the microchannel cooler can be tailored by using a combination of materials (e.g., metal foils) having high thermal conductivities and high CTEs with materials (e.g., metal foils) with lower thermal conductivities and lower CTEs. In its simplest form, the concept uses alternating layers of different material foils to create a cooling structure (e.g., composite cooling structure) with combined or averaged thermal expansion properties. That is, combined material properties of two or more alternating layers of foils allows for better matching thermal expansion properties of a composite cooling structure to a specific heat generating device. For instance, if copper (CTE ˜17.7*10⁻⁶/K) and Invar (CTE ˜0/K) are used as alternating foil layers for the embodiment of FIGS. 1 and 2 to form a composite cooling structure, the net expansion of a cooling surface (through the thickness X direction and/or in-plane Y and Z directions) could range anywhere between the two values, depending on the ratio of copper to Invar. For example, a 50/50 mix is found to give a net CTE of 7.3*10⁻⁶/K, which provides an excellent match to GaAs devices with CTEs of 6.9*10⁻⁶/K. In relation to a cooler fabricated for use with GaAs devices, combined material properties of any materials that fall in an exemplary range of the domain enclosed by the oval entitled “Range for composite cooler for GaAs device” on FIG. 3 would be capable of meeting both thermal performance and expansion goals. Likewise, other domains could be defined for other devices (e.g., SiC with a CTE of approximately 3.7*10⁻⁶/K). Even if a composite cooling structure could not be matched to a range of CTE for a particular device, the thermal mismatch may be significantly reduced.

One innovation brought forth here is that constituent laminates will be formed in such a way as to create microchannel cooling circuitry throughout the matched-expansion structure (or reduced mismatch-expansion structure) to achieve an averaged through the thickness CTE of a cooling surface that better matches a CTE of a heat generating device and achieve a better than averaged thermal resistance for the cooler.

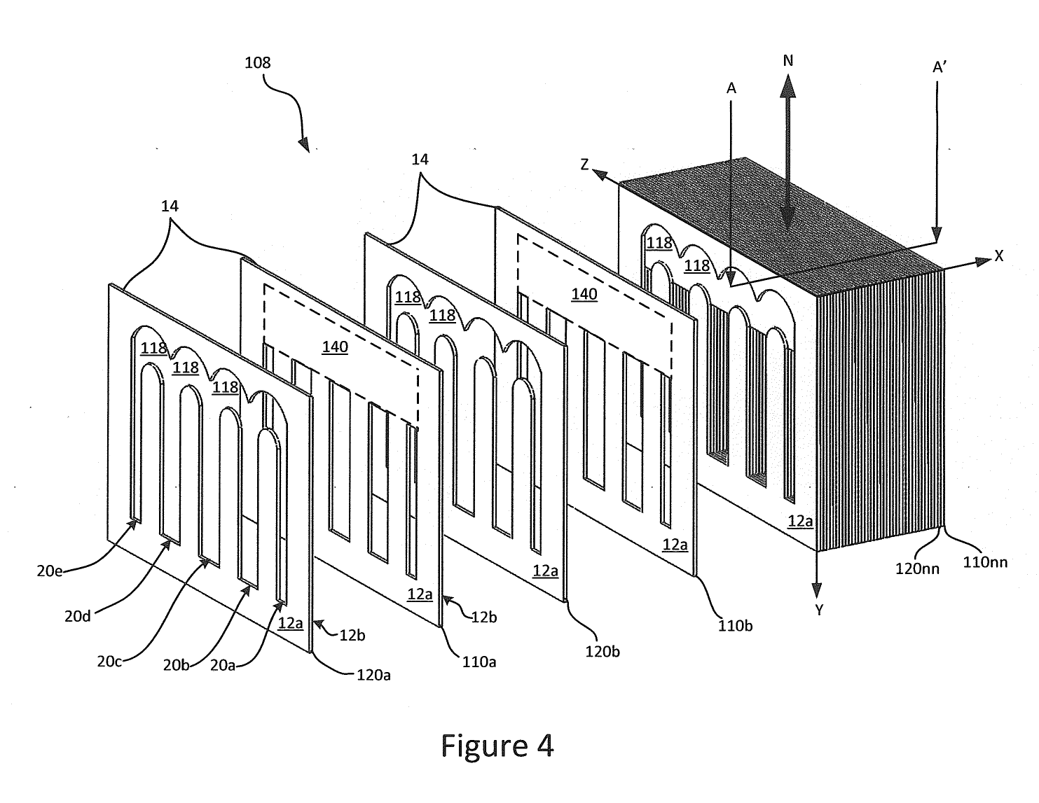

One exemplary design shown in FIG. 4 illustrates a current implementation of a micro channel cooler/device 108 utilizing alternating first foils 110a-nn (hereafter 110 unless specifically referenced) having a high thermal conductivity (k) and a high CTE and second foils 120a-nn (hereafter 120 unless specifically referenced) having lower thermal conductivity (k) and lower CTE. For purposes of discussion and not by limitation, the illustrated design is discussed as using a copper/molybdenum composite or hybrid design. In such an arrangement, the first foils (copper foils) have a thermal conductivity of approximately 400 W/mK and a CTE of approximately 17.7*10⁻⁶/K and the second foils (molybdenum foils) have a thermal conductivity of approximately 138 W/mK and a CTE of approximately 5*10⁻⁶/K. Though discussed herein as utilizing molybdenum and copper plates or foils, it will be appreciated that any two or more materials, which provide a desired combination of properties, may be utilized.

As with the cooler 8 discussed in relation to FIGS. 1 and 2, the foils 110, 120 of the embodiment illustrated in FIG. 4 are stacked and collectively define a cooler 108. In the illustrated embodiment, each of the foils 110, 120 is a substantially rectangular member having first and second planar surfaces or faces 12a and 12b. The thickness of the foil 10 between the faces 12a and 12b defines a peripheral edge of the foil. Again, at least the top edge 14 of each foil 10 is a flat edge such that when the foils 110, 120 are stacked, the top edge 14 of a foil is aligned with the top edge(s) of adjacent foils. Collectively, the top edges 14 define a planar cooling/mounting surface 116 of the cooler 108 for thermal connection with a heat generating device. Alternatively, a planar cooling surface may be machined after the foils are laminated.

In the illustrated embodiment, each of the low CTE/low k foils 120 has one or more flow channels 118 recessed entirely through its thickness between its first face 12a and second face 12b. That is, the flow channels 118 are formed as apertures through the low CTE/low k foils 120. In the illustrated embodiment, each low CTE/low k foil 120 has four flow channels 118 that connect to five flow distribution passages 20a-e. More or fewer flow channels and passages may be utilized based on the configuration of the cooler. Further, the physical orientation, dimensions, and shapes of the flow channels and passages is presented by way of illustration and not by way of limitation. Each flow distribution passage 20a-e extends from a first end of the cooler to a second end of the cooler. As above, the flow distribution passages 20a-e carry coolant to/from manifolds (not shown) when the cooler is in use.

In order to direct flow between the flow distribution passages 20a-20e, when the foils are laminated, the flow channels 118 of each low CTE/low k 120 foil are covered by adjacent high CTE/high k foils 120. In this embodiment, each high CTE foil 110 has a solid portion that extends over the flow channels 118 in an adjacent low CTE foil 120. This solid portion 140 is illustrated as the area enclosed by dashed lines on high CTE foils 110a and 110b in FIG. 4. For example, the second planar surface 12b of the solid portion 140 of high CTE foil 110a covers the flow channels 118 on the front surface of low CTE foil 120b and the first planar surface 12a of the solid portion 140 of high CTE foil 110b covers the flow channels 118 on the back surface of low CTE foil 120b. Thus, when the foils 110 and 120 are bonded, the solid portions of the high CTE foils 110 enclose the flow channels 118 in the low CTE foils 120 to permit coolant to be directed between the various distribution passages 20a-20e.

Typically the low CTE/low k foil 120 (e.g., molybdenum foil) will be bonded in-plane (e.g., YZ plane as arbitrarily illustrated) to the adjacent high CTE/high k, high CTE foil 110 (e.g., copper foil). This bonding of the low CTE foil 120 to the high CTE foil 110 substantially reduces the in-plane thermal expansion of the high CTE foil 110. That is, the thermal expansion of the high CTE foil 110 is limited in the Y and Z directions due to the bonding with the low CTE foil 120 and, depending on the relative strengths of the high CTE foil 110 and the low CTE foil 120, the resulting expansion in these direction may be substantially closer to the expansion of the low CTE foil 120 than the expansion of the high CTE foil 110. However, in the through-the-thickness direction (i.e., X direction) there is no constriction of the high CTE foil 110. Nonetheless, the overall expansion of the resulting cooling structure is reduced in the through-the-thickness direction via the averaging of the expansion properties. That is, if the foils have a common thickness, half of the volume of the device 108 expands in the through-the-thickness direction at the CTE of the low CTE material and half of the volume expands at the CTE of the high CTE material.

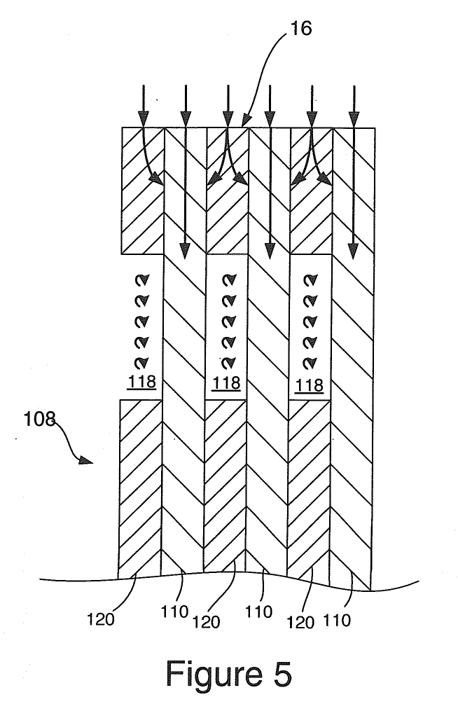

Normally the use of a low CTE foil (e.g., molybdenum) in such a structure would severely degrade the thermal performance of the microchannel device 108 due to, for example, molybdenum's lower thermal conductivity. That is, the inclusion of the low CTE/low k foils would significantly increase the thermal resistance of the cooler. The embodiment shown in FIG. 4 circumvents this problem by locating the flow channel(s) 118 within the low CTE/low thermal conductivity foil 120 and using the adjacent high thermal conductivity foils 110 (e.g., copper) as high-conductivity fins along the vertical faces of the flow channels 118 when the foils 110 and 120 are stacked and bonded to form the device 108. That is, the thermal resistance (illustrated as arrow N) of the hybrid or composite device 108 is closer to the thermal resistance provided by a device made entirely of high thermal conductivity foils. This is due to the high thermal conductivity foils 100 acting as direct conduction pathways from the cooling surface 116 of the cooler 108 to the flow channels 118. Further these foils 100 act as high-conductivity fins along the vertical faces of the flow channels 118 in the low thermal conductivity foils 120, when the foils 110, 120 are stacked and bonded. This is illustrated in FIG. 5, which shows a partial cross-section taken along section lines A-A′ of FIG. 4.

As shown, the alternating high thermal conductivity foils 110 (e.g., copper foils), extend continuously from the cooling surface 116 into the cooling device 108. Further, each high thermal conductivity foil 110 extends over the face of each flow passage 118 (alternatively, flow passages extend on either side of a solid portion of the foil 110). In this regard, the high conductivity foils effectively form fins in the coolant within the flow channels 118. In addition, due to the increased thermal conductivity of the high thermal conductivity foils 110 (e.g., copper foils) relative to the low conductivity foils 120 (e.g., molybdenum foils), the high thermal conductivity foils 110 divert heat from the lower thermal conductivity foils 120. Thus the pathway for a large fraction of the heat flux into the low thermal conductivity foils 120 is short circuited (e.g., shunted) by lateral conduction to the adjacent high thermal conductivity foils 110. Stated otherwise, the thermal constriction resistance in the region between the semiconductor device and the cooling channels with, for example, an all-molybdenum design is reduced by the direct contact with adjacent copper foils. Further, the heat transfer from low thermal conductivity foils 10 to the coolant in the channels 118 only occurs along the top and, to a lesser extent, the bottom of the flow channels 118, which are much smaller in area than the large faces of the high thermal conductivity foils covering the flow passages 118. The convective resistance of the design is therefore close to that of an all-copper design. Thus, the role of the low thermal conductivity foils in the design is minimized, reducing the degradation of the overall thermal performance.

The composite or hybrid design can be used with any material combination, though combinations of high thermal conductivity materials (copper, aluminum, gold, silver) and low expansion materials (Invar, Kovar, Mo, W, Ta, Re, and Ti) are currently believed to offer the most benefit. Further, it will be appreciated that the cooler of FIGS. 1 and 2 could be constructed utilizing alternating foil layers that are physically identical. For instance, alternating layers of half-etched molybdenum and half-etched copper may provide a cooler having reduced CTE mismatch. However, such a cooler may not achieve a desired thermal resistance. That is, an important metric is the thermal resistance of the cooler; the rate at which the cooler can remove heat from a heat generating device. More specifically, it is desirable that the hybrid cooler have a thermal resistance that is much closer to a physically identical cooler made of an all-high thermal conductivity material than that of a physically identical cooler made of an all-low thermal conductivity material. As will be appreciated, the thermal resistance of cooler is related to the thermal conductivity of the material forming the cooler. However, the thermal resistance is also related to the physical configuration of the flow channels below the surface as well its operating conditions. By way of example, thermal resistance of a cooler will change based on the design of the cooling channels below the surface, the thickness of material separating the flow channels from the surface, the flow rate through the flow channels, type of coolant, heat load etc. All of these variables and more may be altered for a particular application. One method of calculating thermal resistance for an actively cooled microchannel cooler is to divide the difference between the average surface temperature of the cooling surface and the coolant inlet temperature by the heat flux applied to the cooler. However, it will be appreciated that other means of calculating the thermal resistance are possible. What is important for comparison purposes, is the thermal resistance of a composite/hybrid cooler relative to a thermal resistance of a physically identical single material cooler under identical operating conditions.

Table 1 compares the thermal characteristics of a cooling surface of three physically identical coolers for the same operating conditions. Specifically, Table 1 compares: 1) an all-Glidcop® cooler (Glidcop® is a copper alloy); 2) an all-molybdenum cooler, and; 3) a hybrid 50/50 molybdenum-Glidcop® cooler. That is, Table 1 compares: 1) a high CTE/high k cooler; 2) a low CTE/low k cooler; and 3) a hybrid cooler formed of the materials of 1 and 2. As shown in Table 1, the hybrid/composite cooler results in a thermal resistance value only 3% higher than the all-Glidcop® cooler, but with the thermal expansion reduced by ⅓ in the plane normal to the foils (through-the-thickness; X direction), and by almost ½ in the foil plane (Y and Z directions).

TABLE 1
Comparison of Nominal and Reduced-
Expansion Cooler Performances

| | R_{T}″ | CTE | |
|---|---|---|---|
| Glidcop ® | 25.8 K-cm²/kW | 16.6 | ppm/K |
| Molybdenum | 39.8 K-cm²/kW | 5 | ppm/K |
| Mo/Cu Hybrid | 26.5 K-cm²/kW | 8 | ppm/K in-plane |
| | | 11 | ppm/K TTT |

As shown, the through the thickness CTE of the hybrid cooler is roughly an average of the materials for a cooler that utilizes alternating foils having the same thickness. However, the thermal resistance of the hybrid cooler is much closer to that of an identical cooler formed entirely of the high CTE/high k material (Glidcop®). This is due to the cooling channels being formed entirely within the low CTE/low k material (e.g., Molybdenum) and the cooling channels being covered on at least one face by the high CTE/high k material. In practice, it is desirable that the thermal resistance of a cooling surface of a hybrid cooler be within 20% of a physically identical cooler made entirely of its high CTE/high k material and yet more desirable to be within 10% or even 5%.

Though primarily discussed above in relation to selecting materials to generate a CTE that is substantially matched to the CTE of a heat generating device, it will be appreciated that reducing the CTE mismatch provides significant thermal stress reduction even if it is not feasible to match the CTE of the heat generating device, For instance, in the case of a diamond substrate having an approximate CTE of 0-1 ppm/K, provision of low thermal resistance microchannel cooler of around 10 ppm/K (i.e., 10× the CTE of diamond) still results in a vast improvement over trying to bond to, for example, a copper microchannel cooler. In this regard, a method for forming a hybrid cooler includes identifying a target CTE (TTT and/or in-plane) for a heat generating device and/or thermal load for the heat generating device. Once these limitations are identified, different materials may be selected to form a hybrid cooler having a matched CTE or reduced-mismatched CTE. Further, the foils (e.g., thicknesses) and/or the physical configuration of the flow channels may be designed to achieve a necessary thermal resistance for the thermal load.

A microchannel cooler in accordance with the present disclosure may be designed for a wide variety of semiconductor/ceramic heat generating devices, including without limitation: Silicon, Silicon Nitride (Si3N4), Fused Silica, Gallium Arsenide (GaAs), GaP, Germanium (Ge), AlN, BN, GaN, SiC, ZrO2, etc. In addition, coolers may be made for ceramic carrier materials such as, without limitation, Al2O3, AlN, Si3N4, SiO2, and BN in addition to semiconductor materials.

Of further note, while in one embodiment, the thicknesses of the different material foils are equal, it will be appreciated that these components may have differing thicknesses. For instance, to tailor a surface to have desired thermal properties, it may be feasible or necessary to use differing thicknesses of the different material (e.g., 1:3; 3:1 etc.). Further, it should be noted that the physical configurations disclosed above are presented by way of example and not by way of limitation. For instance, in the illustrated embodiments, the foils are illustrated as one-piece foils. However it will be appreciated that the foils may be otherwise configured, for example, as multi-piece foils that collectively define the flow channels.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed:

1. A microchannel cooler comprising:
a first set of first foils each having first and second planar surfaces, wherein said first foils are made of a first material;
a second set of second foils each having first and second planar surfaces, and a recess extending across at least said a portion of said second planar surface, wherein said second foils are made of a second material different than said first material; and
wherein said first foils and the second foils alternate in a stack and said first planar surface of each said first foil is bonded to said second planar surface of an adjacent second foil, and wherein each said first foil extends over at least a portion of a recess of said adjacent second foil to define flow channels within said stack, and wherein edges of said first and second foils to define a composite planar surface of said stack.

2. The cooler of claim 1, wherein said first material has a first Coefficient of Thermal Expansion (CTE) and a first thermal conductivity and said second material has a second CTE and a second thermal conductivity, wherein said second CTE is less than said first CTE and said second thermal conductivity is less than said first thermal conductivity.

3. The cooler of claim 2, wherein a composite CTE of said composite planar surface of said stack, in a direction normal to said planar surfaces of said foils forming said stack, is between said first CTE and said second CTE.

4. The cooler of claim 3, wherein said first material has a CTE of at least 10 ppm/K and said second material has a CTE of less than 10 ppm/k.

5. The cooler of claim 4, wherein said first material has a thermal conductivity of at least 180 W/mK and said second material has a thermal conductivity of less than 180 W/mK.

6. The cooler of claim 1, wherein a thermal resistance of said cooler is within 10% of a thermal resistance of a physically identical cooler formed entirely of first and second foils made of said first material.

7. The cooler of claim 6, wherein a thermal resistance cooler is within 5% of a thermal resistance of a physically identical cooler formed entirely of first and second foils of made of said first material.

8. The cooler of claim 1, further comprising:
first and second fluid passages extending through a thickness of said stack in a direction normal to said planar surfaces of said foils forming said stack, wherein said fluid passages are fluidly connected by said flow channels.

9. The cooler of claim 1, wherein a thickness of said first foils measured between said first and second planar surfaces is different from a thickness of said second foils as measured between said first and second planar surfaces.

10. The cooler of claim 1, wherein said recess of each said second foil extends through an entirety of the second foil between said first and second planar surfaces.

11. A microchannel cooler, comprising:
a plurality of first foils made of a first material having a first thermal conductivity and a first Coefficient of Thermal Expansion (CTE), each of said first foils having a first edge surface;
a plurality of second foils made of a second material having a second thermal conductivity of less than said first thermal conductivity and a second CTE of less than said first CTE, wherein each of said second foils includes at least one flow channel recessed through at least a portion of said second foil and a second edge surface;
wherein said first and second foils alternate in a stack, wherein said pluralities of first and second foils are bonded face surface to face surface to form a structure wherein said first and second edge surfaces are aligned to define a planar surface of said structure having a third CTE, in a direction normal to said face surfaces of said foil, between said first CTE and said second CTE.

12. The cooler of claim 11, wherein a solid portion of one of said first foils extends over at least a portion of the flow channel in an adjacent one of said second foils.

13. The cooler of claim 12, wherein said solid portion of said first foil extends continuously from said planar surface to a location beyond said flow channel in said second foil.

14. The cooler of claim 12, wherein a thermal resistance cooler is within 10% of a thermal resistance of a physically identical cooler formed entirely of first and second foils made of said first material.

15. The cooler of claim 12, further comprising:
first and second fluid passages extending through a thickness of said structure in a direction normal to said face surfaces of said foils, wherein said fluid passages are fluidly connected by said flow channels.

16. The cooler of claim 3, wherein said first CTE is at least 10 ppm/K and said second CTE of less than 10 ppm/k.

17. The cooler of claim 4, wherein said first thermal conductivity of at least 180 W/mK and said second thermal conductivity of less than 180 W/mK.

18. A method of fabricating a hybrid cooling plate with a desired Coefficient of Thermal Expansion (CTE), comprising:
selecting a first foil material having a first thermal conductivity and a first CTE;
selecting a second foil material having a second thermal conductivity of less than said first thermal conductivity and a second CTE of less than said first CTE;
alternating first foils made of said first foil material with second foils made of said second foil material and bonding face surfaces of the first and second foils into a structure having a planar surface and a plurality of internal flow paths passing though said second foils and at least partially covered by said first foils, wherein a composite CTE of said planar surface, in a direction normal to said face surfaces of said foils, is closer to said desired CTE than said first CTE.

19. The method of claim 18, further comprising:
selecting a thickness of each of said first and second foils to generate said composite CTE.

20. The method claim 18, wherein said internal flow paths passing though said second foils and said partially covering first foils are designed such that said cooler has a thermal resistance within 20% of a thermal resistance of a physically identical cooler formed entirely from said first foil material.
